(19) United States
(12) Patent Application Publication
(10) Pub. No.: US 2026/0274614 A1
(43) Pub. Date: Sep. 17, 2026

(54) BRAKE SYSTEM

(71) Applicant: INVENTIO AG, Hergiswil (CH)

(72) Inventors: Gunnar Fuchs, Luzern (CH); Oliver Simmonds, Luzern (CH)

(21) Appl. No.: 19/167,067

(22) PCT Filed: Mar. 11, 2024
(86) PCT No.: PCT/EP2024/056387

§ 371 Date: Sep. 19, 2025

(30) Foreign Application Priority Data
Mar. 27, 2023 (EP) 23164246.3

(51) Int. Cl. B66B 5/02; B66B 5/16; B66B 9/00

(52) U.S. Cl. CPC B66B 5/027; B66B 5/16; B66B 9/00

(57) ABSTRACT

A brake system for a traveling body of an elevator has a brake and an emergency cylinder. The brake includes a first brake pad, a spring and a hydraulic element. The spring provides a clamping force that is transmitted to the first brake pad. The hydraulic element provides a brake release force. The emergency cylinder is hydraulically connected to the hydraulic element by a hydraulic line and is actuated using muscle power to release the brake. The emergency cylinder, the hydraulic line and the hydraulic element can be separated by a separating valve. An operating method includes the steps of: separating the emergency cylinder, the hydraulic element and the connecting hydraulic line by closing the separating valve; releasing the brake by actuating the emergency cylinder using muscle power; and braking the traveling body with the brake by ending the actuation of the emergency cylinder.

### FIELD

The present invention relates to a brake system for a traveling body of an elevator, the traveling body, the elevator and a method for emergency opening of the brake of the brake system.

### BACKGROUND

In an elevator system, a car is typically moved vertically along a travel path between different floors or levels within a building. At least in tall buildings, an elevator type is used in which the car is held by rope or belt-like suspension means and displaced within an elevator shaft by moving the suspension means by means of a prime mover. In order to at least partially compensate for the load of the car that must be moved by the prime mover, a counterweight can be fastened to an opposite end of the suspension means. The car and counterweight are the traveling bodies of the elevator. In order to protect the traveling bodies from falling along the travel path, the traveling bodies are often equipped with brakes. Such brakes can be configured as hydraulic brakes.

For safety reasons, hydraulic brakes are typically configured so that they are preloaded by a spring in a braking position and released by a hydraulic actuator. U.S. Pat. No. 9,688,510B2 discloses a hydraulic brake in which springs for preloading a hydraulic brake are housed in the brake cylinders. U.S. Pat. No. 10,450,165B2 also discloses springs for preloading a hydraulic brake in the brake cylinders.

This means that the brakes are configured to be fail-safe. If there is a fault in the system, such as a power failure or a defect in a hydraulic hose, the hydraulic actuator fails and the brake is applied. The traveling body is thus braked and can only be displaced with great difficulty. In particular, the traveling body does not fall. The springs press on the brake with great clamping force, so that a brake pad is pressed against a brake rail with sufficient normal force. Thus, according to the friction formula, sufficient braking force is generated in interaction with the brake rail. As a result, however, it is also prevented that a traveling body is moved toward a shaft door, for example to free passengers from the car in an emergency.

EP3097038B1 shows a removable crank to manually operate a pump of a hydraulic brake system and thereby release the hydraulic brake in case of a power failure. As a result, the car can be moved, but operating the hand crank and additional valves by the service technician is complicated and physically demanding.

It can therefore be seen as a task to make it possible for the traveling body to be moved in a simple manner even during a power failure.

### SUMMARY

According to a first aspect of the invention, a brake system for a traveling body of an elevator achieves the object. The brake system has a brake and an emergency cylinder. The brake has a first brake pad, a spring and a hydraulic element. The spring is configured to provide a clamping force for the brake. The clamping force can be transmitted to the first brake pad. The hydraulic element is configured to provide a release force. The emergency cylinder is hydraulically connected to the hydraulic element by a hydraulic line, and the emergency cylinder can be actuated using muscle power. The actuation of the emergency cylinder releases the brake. A closed hydraulic section can be separated by a separating valve, and the hydraulic region comprises the emergency cylinder, the hydraulic line and the hydraulic element.

According to a second aspect of the invention, a traveling body of an elevator with a brake system according to the first aspect of the invention achieves the object. The emergency cylinder is arranged on the traveling body.

According to a third aspect of the invention, an elevator with a brake system according to the first aspect of the invention achieves the object. The actuator is mounted in a machine room of the elevator or on the traveling body.

According to a fourth aspect of the invention, a method for the emergency opening of a brake of a brake system according to the first aspect of the invention achieves the task: The method comprises the steps of:
Separating a closed hydraulic region by closing the separating valve, wherein the hydraulic region comprises the emergency cylinder, the hydraulic element and the hydraulic line.
Releasing the brake by actuating the emergency cylinder using muscle power.
Braking with the brake by stopping the actuation of the emergency cylinder.

Possible features and advantages of embodiments of the invention can be regarded, inter alia and without limiting the invention, as being based upon the concepts and findings described below.

It is advantageous that the braking force is provided by the spring, since this ensures that the brake always closes safely if this is necessary. The brake is only released if the elevator is working within normal parameters, for example if the power supply and the control system are working, and if the operating state of the elevator allows it. In the event of a power failure, a drain valve opens, draining the hydraulic fluid from the hydraulic element into a tank, and the brake closes. The drain valve preferably only closes if it is energized. A pump can then pump hydraulic fluid from a tank into the hydraulic element. As a result, the brake is released. After the journey has ended, the power supply to the pump and drain valve can be interrupted and the hydraulic fluid from the hydraulic element flows through the drain valve into the tank.

The first brake pad of the brake is used to provide a braking force on a brake rail by pressing the first brake pad against the brake rail with a clamping force. The clamping force provides a frictional force on the brake rail via a friction coefficient. The first brake pad has a surface that is suitable for providing a braking force on the brake rail.

The aspects of the invention allow a traveling body, and in particular a car, to be moved during a prolonged power failure. The emergency cylinder is preferably configured as a single-acting hydraulic cylinder with a displaceable piston in a cylinder. The closed hydraulic region preferably consists substantially of the emergency cylinder, the hydraulic element and the hydraulic line connecting the two. This closed hydraulic region is sealed by closing the separating valve, so that the hydraulic fluid contained therein circulates exclusively in the closed hydraulic region. Therefore, the hydraulic fluid cannot leave the closed hydraulic region. In particular, the separating valve separates the further hydraulic components of the brake system, such as the tank, the pump or the drain valve, from the closed hydraulic region. A hydraulic fluid used is preferably substantially incompressible. As a result, it is ensured that the volume of hydraulic fluid flowing into the hydraulic line when the emergency cylinder is actuated flows completely into the hydraulic element. Therefore, the hydraulic fluid cannot flow into the tank via the drain valve, which is open during a power failure, and the hydraulic fluid cannot flow into the tank through the pump.

Due to the separation, a movement of the emergency cylinder is directly coupled with a movement of the hydraulic element. Wherein the spring of the brake ensures that the brake is closed without actuating the emergency cylinder and the hydraulic fluid is displaced to the emergency cylinder. Due to the actuation of the emergency cylinder, the hydraulic fluid can be displaced into the hydraulic element of the brake and releases the brake. For this purpose, the actuator must be actuated using muscle power. As soon as the actuator is no longer actuated, the spring displaces the hydraulic fluid back into the emergency cylinder and the brake closes again. As a result, the traveling body, or the car, is once again held securely.

An arrangement on the traveling body, or specifically on the car, makes the emergency cylinder easily accessible. In an emergency, the technician can gain access to the car roof through a shaft door and from there check the brakes of the car.

The actuator is used to transmit the muscle power of a person to the emergency cylinder. For example, a mechanic, a service technician, a building maintenance employee or a firefighter can operate the actuator using muscle power and thereby release the brake.

Opening the brake is referred to as releasing the brake. When the brake is released, an air gap can occur between the brake pad and the brake rail. Preferably, the release is already achieved if the normal force between the brake pad and the brake rail is reduced so much that the traveling body can be set in motion.

According to a preferred embodiment, the emergency cylinder can be actuated using muscle power using a manually separable actuator. The actuator can, for example, be configured as a handle with a rope that can be pulled. The rope can run over a plurality of pulleys, so that a block-and-tackle effect amplifies the force exerted on the handle and transmits it to the emergency cylinder. Alternatively, it can be a handwheel that can be turned. The rotation can be translated into a movement by a thread, which then actuates the emergency cylinder.

According to a preferred embodiment, the brake system comprises an emergency cylinder mechanism for establishing an operative connection between the actuator and the emergency cylinder, wherein the emergency cylinder mechanism comprises a first part and a second part, which are pivotally connected to one another.

The emergency cylinder mechanism serves to hold the emergency cylinder, accommodate the actuator, and guide the actuator, so that the actuation movement is transmitted to the emergency cylinder. Preferably, a first part of the emergency cylinder mechanism is connectible to the traveling body, and a second part of the emergency cylinder mechanism is configured to interact with the actuator. The actuator can be attached to the emergency cylinder mechanism, for example by plugging, screwing or hooking it in order to interact with the emergency cylinder mechanism.

The actuator can interact with an emergency cylinder mechanism so that the mechanism transmits a movement of the actuator to the emergency cylinder. Preferably, the emergency cylinder is held on the emergency cylinder mechanism.

According to a preferred embodiment, the actuator is configured as a lever. The lever is a simple technical means to translate a high ratio from the limited muscle power to a force that moves the emergency cylinder. Therefore, the lever is particularly advantageous. Preferably, the lever interacts with the emergency cylinder mechanism at one of its ends by transmitting a force couple to the emergency cylinder mechanism. At the other end of the lever, a person pulls or pushes the lever.

The actuation of the emergency cylinder may require a great deal of force. Therefore, the emergency cylinder can be actuated with the actuator, which is preferably mounted separately. The actuator can be configured as a lever and, for example, inserted into a sleeve of the emergency cylinder mechanism. The sleeve and one end of the lever can be configured to be conical. The lever can also simply engage an eyelet on the emergency cylinder mechanism. The actuator can alternatively be configured as a handwheel. The emergency cylinder mechanism preferably comprises a thread, so that due to the rotation of the handwheel, a threaded rod actuates the emergency cylinder.

A separable actuator has the advantage that the actuator does not have to be permanently connected to the emergency cylinder or the emergency cylinder mechanism. In particular, an actuator configured as a lever can be very long and would be disruptive on the traveling body, and especially on the car roof. In particular, the lever could, for example, interfere with a safety region on the car roof or the distance to a shaft ceiling. A separable, i.e. removable or dismountable, actuator can be mounted elsewhere, so that it does not interfere with the operation of the elevator.

The use of a lever as an actuator is particularly advantageous, since it is easy to carry and can be inserted into the emergency cylinder mechanism. In the simplest case, the lever can be a tube. One end of the actuator can also be configured to hold in the emergency cylinder mechanism. For this purpose, the actuator and the receptacle of the actuator in the emergency cylinder mechanism can, for example, be configured to be slightly conical.

According to a preferred embodiment, the lever is longer than 0.5 m. In particular, levers that are longer than 1 m, 1.5 or 2 m are also suitable as actuators. The actuator is preferably mounted in the machine room. This has the advantage that only people who have access to the machine room, i.e. trained personnel, can handle and use the actuator. Alternatively, the lever can also be mounted on the car roof, i.e. near the emergency cylinder. This has the advantage that there is no need to go to the engine room.

According to a preferred embodiment, the traveling body is configured as a car. The car is easily accessible through the shaft doors. The roof of a car is easy to access and offers enough space to actuate the emergency cylinder. Therefore, it is advantageous to arrange the emergency cylinder, and in particular the emergency cylinder mechanism, on the roof of the car.

The actuator can be mounted on the traveling body or in the machine room. In particular, if the traveling body is configured as a car, the actuator can be arranged either on the car roof, for example on a balustrade or on an upper yoke. Alternatively, the actuator can also be arranged on the side of the car, for example on a stand of the car structure or on the outside of the car wall. The advantage of such an arrangement is that the actuator on the car roof is always quickly accessible. In particular, it is accessible exactly where it is used.

The advantages of mounting the actuator in the machine room are that the machine room is closed, thus ensuring safe and clean storage of the actuator.

According to a preferred embodiment, the method according to the invention can further comprise the step of:
Attaching the actuator to the emergency cylinder.

According to a preferred embodiment, the method according to the invention can further comprise the step of
Displacing the adjustable stop in order to set the position of the actuator at which the brake is released.

The brake is released if the emergency cylinder has reached a certain position. The position depends in particular on how far a brake pad has already worn down. The more worn the brake pad is, the further the emergency cylinder can be moved until the brake is released. In this position, the emergency cylinder has displaced a certain volume of hydraulic fluid.

If the stop is poorly set, the emergency cylinder may be difficult to operate. For example, it may be necessary to move the actuator so far that the actuator hits an object before reaching the position where the brake is released. Such an object can be, for example, the roof of the car, a balustrade or a wall. Alternatively, the actuator is difficult to operate, since it has to be actuated in a starting position that is difficult to reach.

The actuator and thus the emergency cylinder are preferably relieved in order to displace the stop. Due to the displacement of the adjustable stop, the position at which the brake is released can be set so that this position is comfortable to operate. In the event that the actuator is configured as a lever, this may mean that the stop is set so that the lever, in the position in which the brake is being released, runs substantially horizontal and a short distance above the standing surface of an operator. In this position, the lever can be held with one foot and the braking force can be regulated by slight up or down movements.

If the traveling body is set in motion at a position of the actuator at which the actuator was easy to operate, it can continue to be used. However, if the actuator strikes the traveling body or the shaft wall before the traveling body begins to move, or if the position in which the traveling body is just set in motion is uncomfortable to maintain, the adjustable stop can be displaced until the actuator is convenient to operate if the traveling body is just set in motion.

Now, the following two steps can be performed:
Releasing the brake by actuating the emergency cylinder using muscle power.
Braking with the brake, by freeing the emergency cylinder.

These steps are preferably repeated several times. Each time, the brake is released enough to cause the traveling body to be set in motion. For this purpose, it is sufficient to reduce the normal force between the brake pad and the brake rail to such an extent that the friction force is no longer sufficient to hold the traveling body. There is no need for a gap to form between the brake pad and the brake rail. Due to the freeing of the actuator and thus the emergency cylinder, braking is then applied again. Alternatively, the braking force can be controlled by the operator to maintain a slow journey. As soon as a floor is reached, i.e. if the car is located sufficiently precisely at a floor for the passengers to leave the car, the actuator is freed by the operator and the brake is applied again.

According to a preferred embodiment, the method according to the invention can further comprise the step of:
Operating the actuator by a person with one foot,
wherein preferably the actuator is aligned substantially horizontally.

As a result, the operation of the actuator by the person, i.e. the operator, is particularly safe. The person has their hands free to hold on to the balustrade on the traveling body, for example. As soon as the person pulls their foot even slightly away from the actuator, thereby relieving the pressure on the actuator, the brake is immediately applied safely again.

The first brake pad of the brake is configured to be pressed against a brake rail and thereby provide a braking force. The first brake pad can have a first brake pad. The first brake pad can be adjusted to be perpendicular to the braking surface or at a different angle to the braking surface. The adjustment to the braking surface can be provided by the spring. This means that the spring provides a clamping force on the first brake pad, with which the first brake pad is pressed against the brake rail. Thus, the brake rail is clamped with this clamping force.

A single first brake pad can press against a brake rail, and the brake rail can be configured to be sufficiently firm in order to not be deformed. For this purpose, the brake rail, for example, is firmly anchored to the building. The brake rail can be designed to be so stable that the brake rail can transmit the clamping force with which the first brake pad presses against the rail into the building. The brake rail can substantially retain its shape.

The brake can have a second brake pad, wherein the clamping force can be transmitted to the second brake pad, so that the clamping force can be applied to a brake rail from opposite sides. The second brake pad can be displaced relative to a housing of the brake, or be fixed to or connected to the housing. The second brake pad can be suitable for providing frictional force when pressed against the brake rail.

Preferably, in each case two brake pads work in pairs. Alternatively, a first brake pad acts on a first surface of the brake rail and a sliding pad or roller acts on a second surface of the brake rail opposite the first, so that the clamping forces on the two opposite surfaces of the brake rail cancel each other out. There is substantially no displacement of the brake rail due to the brake and its clamping forces. This can be supported by mounting the brake in a floating manner, i.e. so that it can be displaced horizontally.

The hydraulic element counteracts the clamping force provided by the springs. The hydraulic element can be actuated, for example, with hydraulic oil as the hydraulic fluid. Normally, if there are no problems in the elevator, pressure is built up in the hydraulic element, for example by an electrically operated pump, in order to move the hydraulic piston. The hydraulic piston then releases the brake. In normal operation, i.e. when the separating valve is open, the hydraulic element is connected to the pump and the drain valve as well as to the emergency cylinder.

According to a preferred embodiment, the emergency cylinder is configured to increase the pressure in the hydraulic element when the emergency cylinder is actuated in order to release the brake. For this purpose, the cross-section of the emergency cylinder is preferably smaller than the cross-section of the hydraulic element on the brake. As a result, a force transmission once again arises.

According to a preferred embodiment, a first stroke volume of the emergency cylinder is greater than a volume of hydraulic fluid that is required in order to release the brake by the hydraulic element. Thus, the volume of hydraulic fluid that can be displaced from the emergency cylinder is greater than the volume of hydraulic fluid that can flow into the hydraulic element until the brake is released. Thus, the stroke volume of the emergency cylinder has a reserve. Therefore, even with a small loss of hydraulic fluid, the brake can nevertheless be released. In particular when using multiple brakes, the volume is larger than the volume of hydraulic fluid that is required in order to release all brakes.

According to a preferred embodiment, the emergency cylinder mechanism has an adjustable stop in order to set the position of the actuator at which the brake is released.

Preferably, the actuator can be actuated with the foot. The actuator is attached to the emergency cylinder, and in particular to the emergency cylinder mechanism. The end of the actuator to be actuated can be located high up, for example 1 m to 2 m above the car roof. By pressing down, the brake is released and the car can move. This is particularly easy and comfortable if the actuator, in the actuated state, is only slightly above the car roof on which the person actuating the actuator is standing. The actuated state is the one in which the car is just beginning to move. Depending on the age or wear state of the first and/or second brake pad and the elasticity of the hydraulic line, it may be necessary to operate the actuator to different extents in order to release the brake. It is therefore advantageous to adjust the adjustable stop of the emergency cylinder mechanism so that the actuator can be actuated in a comfortable position. In particular with a foot-actuated lever, it is advantageous that the brake is released if the lever is substantially horizontal and slightly above the car roof. As a result, the person actuating it has their hands free, for example to hold on to something. On the other hand, the person can free the brake or apply the brake again by gently lifting and lowering their foot on the lever.

The adjustable stop can, for example, comprise a displaceable body that fastens the actuator at a different angle in the emergency cylinder mechanism depending on its position. It is also possible to displace the stop by combining a screw with a thread. For example, it is also possible to provide a plurality of holes for a fastening bolt for attaching the actuator. Depending on the hole selected, a different angle can be set.

If a traveling body or, in particular, a car is held between floors by the brake, an authorized person can remove the actuator from its mounting location and proceed to the emergency cylinder. The actuator is attached to the emergency cylinder mechanism and actuated until the traveling body moves and then immediately released again.

Further advantages, features, and details of the invention can be found in the following description of exemplary embodiments and with reference to the drawings, in which like or functionally like elements are provided with identical reference signs. The drawings are merely schematic and are not to scale.

### DESCRIPTION OF THE DRAWINGS

In the drawings:

FIG. 1 shows an elevator,

FIG. 2 shows an emergency cylinder mechanism in maximum actuated position,

FIG. 3 shows the emergency cylinder mechanism from FIG. 2 in section,

FIG. 4 shows the emergency cylinder mechanism from FIG. 3 in an unactuated position,

FIG. 5 shows a brake,

FIG. 6 shows a hydraulic diagram of the brake system and

FIG. 7 shows a diagram of the method.

### DETAILED DESCRIPTION

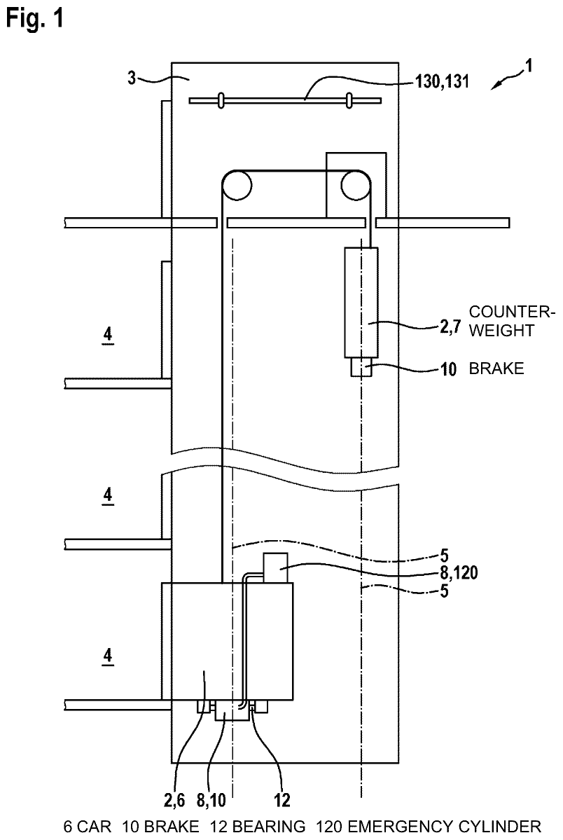

FIG. 1 shows an elevator 1. In the elevator 1, a car 6 is typically moved vertically between different floors 4 or levels inside a building. In order to compensate for the weight of the car 6, the elevator 1 has a counterweight 7. The car 6 and the counterweight 7 can also be referred to as traveling bodies 2, since they are moved along rails, which also serve as brake rails 5. In order to brake the traveling bodies 2 when necessary, these have a brake 10.

For the travel comfort of the passengers, it is advantageous that the traveling body 2, and in particular the car 6, can easily move horizontally relative to the brake rail 5. The brake rail 5 always has small bumps; thanks to an elastic bearing with 4 to 5 mm play, car 6 can follow these bumps with a delay. However, the brake preferably has a much smaller play, for example 1 mm to 2 mm. In order to achieve this, the brake 10 on the car 6 is guided in a floating manner on a brake plain bearing 12. As a result, the brake 10 can follow the bumps of the brake rail 5, and the car 6 is isolated from these rapid movements. Thus, the car 6 does not follow the small deflections of the brake rail 5.

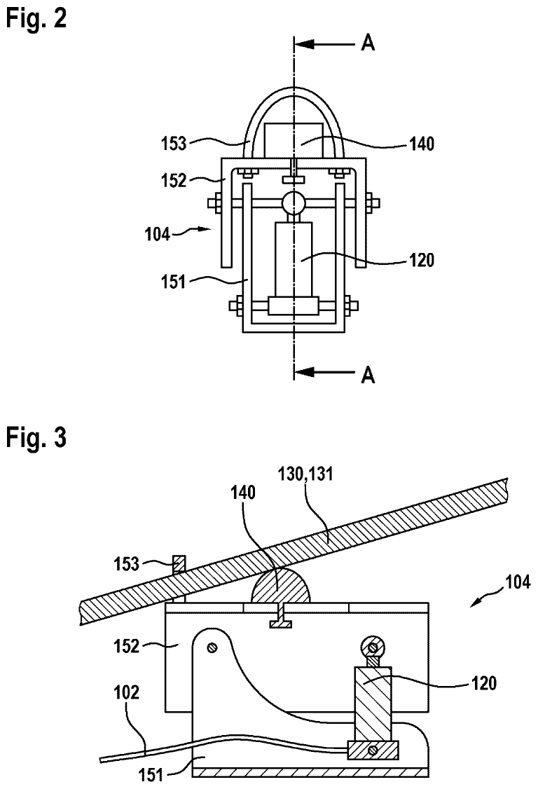

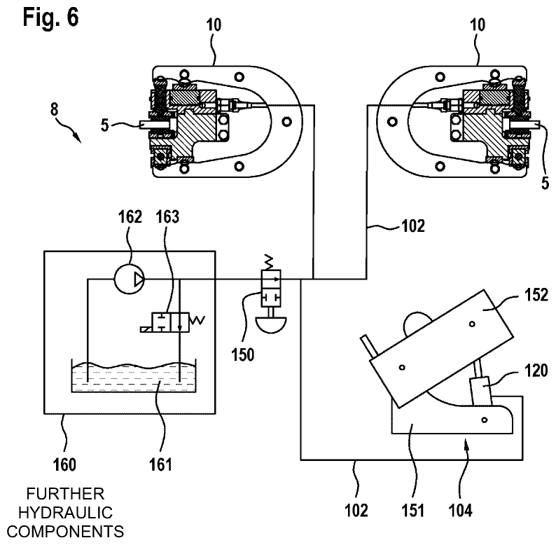

The brake 10 is part of a brake system 8. The brake system 8, with the exception of the actual brake 10 and a hydraulic line to the brake 10, is preferably arranged on the roof of the car 6. As a result, the brake system 8 is easy to maintain. The brake system 8 comprises, for example, the components as shown in FIG. 6. An emergency cylinder 120 and/or an emergency cylinder mechanism, as shown in FIGS. 2-4, are also preferably located as part of the brake system 8 on the roof of the car 6.

An actuator 130 can be designed as a lever 131. Preferably, the actuator 130 is mounted in a machine room 3 of the elevator 1. Alternatively, it could also be mounted on or near car 6.

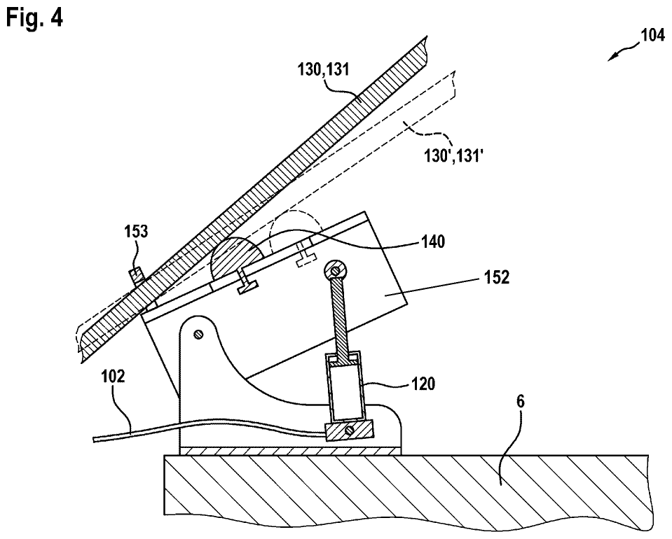

FIG. 2 shows a view of an emergency cylinder mechanism 104 and FIG. 3 shows a section A-A through the emergency cylinder mechanism 104 with the emergency cylinder 120. A first part 151 of the emergency cylinder mechanism 104 can be firmly connected to the traveling body or the car. A second part 152 of the emergency cylinder mechanism 104 is pivotally mounted on the first part 151. In FIG. 2 and FIG. 3, the emergency cylinder 120 is shown maximally actuated. FIG. 4 then shows the emergency cylinder 120 in the unactuated position. The emergency cylinder 120 has its shortest possible length. Alternatively, in other words, the piston of the hydraulic cylinder, of which only the outer part of the piston rod is shown, is pushed into the cylinder as far as it will go. A brake connected to the emergency cylinder 120 via the hydraulic line 102 would thus be widely released, since the entire volume of hydraulic fluid would be moved from the emergency cylinder 120 into the hydraulic element 18.

The actuator 130 can be inserted into an eyelet 153. The actuator 130, which acts as a lever 131, can transmit a torque to the second part 152 by providing a force on the eyelet 153 and the stop 140 in each case. Due to the adjustment of the adjustable stop 140, the angle between the second part 152 and the actuator 130 can be set.

FIG. 4 shows the same embodiment as FIG. 3. However, the emergency cylinder mechanism 104 is shown here in a partially actuated position. The actuator 130, i.e. the lever 131, is located high above the floor on the car roof. This can be uncomfortable when actuated with the foot. Due to the displacement of the stop 140 further to the right, a different position of the actuator 130′, i.e. the lever 131′, would be achieved. As a result, the angle between the actuator 130 and the second part 152 changes and the actuator 130 comes to lie in a different position for the same position of the emergency cylinder 120. Preferably, the stop 140 is set so that the actuator 130 is in a comfortable position to operate if the brake is released just enough to allow the car 6 to be set in motion.

Alternatively, the height of the adjustable stop 140 or the opening of the eyelet 153 could be adjustable, for example by a thread. As a result, the angle between the actuator 130 and the second part 152 could likewise be adjusted with a view to good operability.

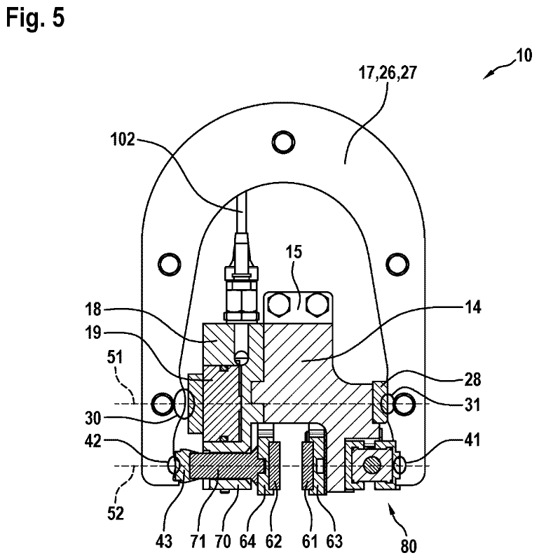

FIG. 5 shows a brake 10 as it could be used in the brake system. A spring 17 engages around a housing 14 of the brake 10. The spring 17 is configured so that it can widen. The spring 17 is formed by a C-spring assembly 26, which consists of individual C-shaped leaf springs 27. The spring 17 provides the clamping force of the brake 10.

A hydraulic element 18, in particular a hydraulic piston 19, and a counter holder body 28 are arranged along a first line of action 51. In a braking position, the hydraulic piston 19 is retracted into the hydraulic element 18. In the case of a hydraulic bearing 30, there is preferably play between the spring 17 and the hydraulic piston 19. There is play in a counter-bearing 31 and the spring 17 is preferably spaced apart from the counter holder body 28. Thus, no force is transmitted along the first line of action 51.

The clamping force provided by the spring 17 is transmitted completely along a second line of action 52. In the case of a first brake bearing 41, the clamping force is transmitted to the housing 14 via a preload element 80. The housing 14 is also firmly connected to a first brake pad holder 63 and a first brake pad 61 held thereon. On the opposite side, in the case of a second brake bearing 42, the clamping force is transmitted to a plunger 71 via a bearing plate 43. The plunger(s) 71 is/are also firmly connected to a second brake pad holder 64 and a second brake pad 62 held thereon. The plungers 71 are guided in a linear guide 70 so as to be linearly displaceable. The linear guide 70 is designed as a bore. In the braking position, a brake rail is clamped between the first brake pad 61 and the second brake pad 62, thereby generating the braking effect.

In order to reach the released position, hydraulic fluid is pressed into the hydraulic element 18 via the hydraulic line 102. The hydraulic piston 19 presses on the hydraulic bearing 30. Together with the counter bearing body 28 which presses on the counter bearing 31, the brake spring 17 is thereby widened. The clamping force transmitted along the second line of action 52 decreases. When the hydraulic pistons 19 are fully extended, the first brake pad 61 and the second brake pad 62 have a play relative to the brake rail. The contact at the second brake bearing 42 is maintained. For this purpose, the bearing plate 43 can be configured magnetically so that it moves with the spring 17.

The housing 14 can be fastened to a brake plain bearing via a fastening region 15.

FIG. 6 shows a brake system 8 comprising two brakes 10, as shown for example in FIG. 5, and an emergency cylinder 120, as shown for example in FIGS. 2 to 4. The emergency cylinder 120 is connected to the two brakes 10 via a hydraulic line 102. Further hydraulic components 160 are connected to the hydraulic line 102 via a separating valve 150. Due to the closing of the separating valve 150, the further hydraulic components 160 are separated from the emergency cylinder 120, the brakes 10 and the hydraulic line 102 connecting the two. The further hydraulic components 160 are, for example, a tank 161 for storing the hydraulic fluid, a pump 162 for pumping hydraulic fluid to the brakes 10 and/or at least one drain valve 163 for draining the hydraulic fluid from a hydraulic element of the brake 10. By activating the pump 162, the brake 10 can be released, by opening the drain valve 163, the brake 10 can be closed.

In the event of a power failure, an operator can proceed to the roof of the car. Due to the actuation of the separating valve 150, it is ensured that the hydraulic fluid from the emergency cylinder 120 is directed into the brakes 10. Thus, the hydraulic fluid cannot flow into the tank 161, for example via the pump 162. The compression of the emergency cylinder 120 thus leads to a release of the brakes 10, so that the car can be set in motion.

The separating valve 150 is preferably configured so that it is open during normal operation. For example, by pressing a button, the separating valve 150 can be closed and preferably remains in this position thanks to a locking device (not shown). The locking device can be released again after the evacuation in order to operate the brakes 10 normally again.

Due to the closing of the separating valve 150, a closed hydraulic region is formed. The hydraulic line 102 serves to direct the hydraulic fluid from the emergency cylinder 120 to the hydraulic element 18 of the brake 10. The hydraulic region is separated from further hydraulic components, such as the pump 162, the drain valve 163 or the tank 161, by the separating valve 150, so that the hydraulic fluid is directed exclusively into the hydraulic element of the brake 10. As a result, the brake 10 is released and a brake rail 5 is freed.

The emergency cylinder 120 is actuated by an actuator that is attached to a second part 152 of the emergency cylinder mechanism 104. For example, a first part 151 of the emergency cylinder mechanism 104 is firmly attached to the car. The actuator then provides a relative movement between the first part 151 and the second part 152 of the emergency cylinder mechanism 104. As a result, hydraulic fluid is displaced from the emergency cylinder 120 through the hydraulic line 102 to the brake 10. The brake 10 is thereby released.

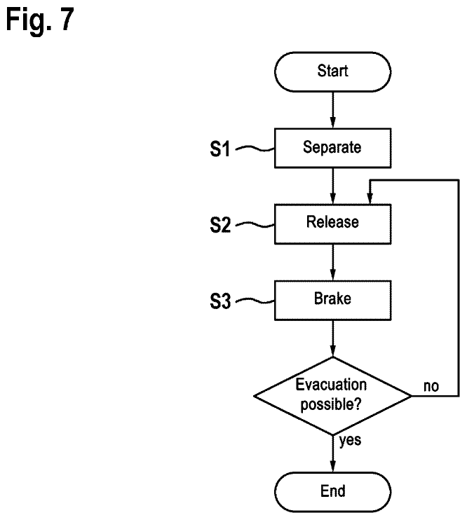

FIG. 7 shows the steps of the method. The method starts with a situation in which the traveling body can no longer be moved by the drive, for example as a result of a power disruption. In the step S1, the separating of the emergency cylinder, the hydraulic element and the hydraulic line connecting the two is carried out by closing the separating valve. As a second step S2, the brake is released by actuating the emergency cylinder using muscle power. As a third step S3, braking using the brake is carried out by freeing the emergency cylinder.

The step S2 of releasing and the step S3 of braking are repeated until the traveling body has reached a position in the shaft that allows the passengers to leave the traveling body. Then, an evacuation is possible.

The attachment of the actuator can be carried out at the emergency cylinder directly before or after step S1, i.e., separating.

The displacement of the adjustable stop in order to set the position of the actuator at which the brake is released is preferably carried out before the releasing S2 of the brake. The displacement can be carried out before a first release S2 or before a repeated release S2 of the brake.

The step S3 braking is carried out by a person operating the actuator with a foot, wherein preferably the actuator is aligned substantially horizontally.

Finally, it should be noted that terms such as “having”, “comprising”, etc. do not preclude other elements or steps, and terms such as “a” or “one” do not preclude a plurality. Furthermore, it should be noted that features or steps which have been described with reference to one of the above exemplary embodiments may also be used in combination with other features or steps of other exemplary embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A brake system for braking a traveling body of an elevator, the brake system comprising:
a brake on the traveling body, the brake having a first brake pad, a spring and a hydraulic element, wherein the spring provides a clamping force of the brake, the clamping force being transmitted to the first brake pad to clamp the brake on a brake rail of the elevator in an actuated position, and the hydraulic element provides a release force to release the brake to an unactuated position;
an emergency cylinder hydraulically connected to the hydraulic element by a hydraulic line, the emergency cylinder being actuated using muscle power to release the brake to the unactuated position; and
a separating valve that, when closed, separates a hydraulic region from further hydraulic components of the brake system, the hydraulic region including the emergency cylinder, the hydraulic line and the hydraulic element.

17. The brake system according to claim 16 wherein the emergency cylinder increases a pressure in the hydraulic element when the emergency cylinder is actuated to release the brake.

18. The brake system according to claim 16 wherein a first stroke volume of the emergency cylinder is greater than a volume of hydraulic fluid required by the hydraulic element to release the brake.

19. The brake system according to claim 16 wherein the emergency cylinder is actuated with a manually operated actuator.

20. The brake system according to claim 19 including an emergency cylinder mechanism operatively connecting the actuator and the emergency cylinder, wherein the emergency cylinder mechanism includes a first part pivotally connected to a second part.

21. The brake system according to claim 20 wherein the emergency cylinder mechanism has an adjustable stop that sets a position of the actuator at which the brake is released.

22. The elevator system according to claim 19 wherein the actuator is a lever.

23. The brake system according to claim 22 wherein the lever is longer than 0.5 m.

24. A traveling body of an elevator, the traveling body comprising:
the brake system according to claim 16 arranged to brake the traveling body; and
the emergency cylinder of the brake system being arranged on the traveling body.

25. The traveling body according to claim 24 wherein the traveling body is an elevator car.

26. An elevator comprising:
a machine room;
a traveling body; and
the brake system according to claim 16 wherein the emergency cylinder is actuated with a manually operated actuator, the actuator being mounted in the machine room or on the traveling body.

27. A method for operating a brake system, the method comprising steps of:
providing the brake system according to claim 16;
separating a closed hydraulic region by closing a separating valve, wherein the closed hydraulic region includes the emergency cylinder, the hydraulic element and the hydraulic line connected to the separating valve;
releasing the brake by actuating the emergency cylinder using muscle power; and
braking a traveling body with the brake by stopping the actuation of the emergency cylinder.

28. The method according to claim 27 including a step of attaching an actuator to the emergency cylinder.

29. The method according to claim 28 including a step of displacing an adjustable stop to set a position of the actuator at which the brake is released.

30. The method according to claim 28 including a step of operating the actuator by a person using one foot, wherein the actuator is aligned horizontally relative to a horizontal surface supporting the person.
